(19) United States
(12) Patent Application Publication
(10) Pub. No.: US 2019/0028436 A1
(43) Pub. Date: Jan. 24, 2019

(54) APPARATUS AND METHOD FOR FORWARDING OF DATA PACKETS

(71) Applicant: GIESECKE+DEVRIENT MOBILE SECURITY GmbH, München (DE)

(72) Inventor: Jens KULIKOWSKI, Oberding (DE)

(21) Appl. No.: 16/064,597

(22) PCT Filed: Dec. 20, 2016
(86) PCT No.: PCT/EP2016/002142

§ 371 Date: Jun. 21, 2018

(30) Foreign Application Priority Data
Dec. 22, 2015 (DE) 102015016715.4

(51) Int. Cl. H04L 29/06

(52) U.S. Cl. CPC H04L 63/0245; H04L 69/16; H04L 63/0236

(57) ABSTRACT

A method is for forwarding data packets from an external network by means of a transmission device to a device to be secured. The transmission device has a first interface for connecting to the external network and a second interface for connecting to the device to be secured. Received data packets are in dependence on at least one property of the respective data packet and pre-specified rules of the packet filter, and are or are not forwarded to the second interface. Every data packet incoming via the first interface is checked whether it contains pre-specified recognition information item in a useful data unit of the Internet layer of the TCP/IP model, and only if this is the case useful data of the data packet for changing the transmission device are stored or forwarded to a process for changing the transmission device.

The present invention relates to a method for forwarding of data packets from an external network by means of a transmission device to a device to be secured, means for carrying out the method as well as a method for the changing of the transmission device.

Security-critical devices, for example devices which store sensitive data which should not be made accessible to arbitrary third parties, or infrastructure devices or supply devices like power plants or transformer stations or devices for treating or processing objects or materials, often have network interfaces via which they can receive and, where applicable, send data. Within the scope of the present application, such a security-critical device or a network having at least one such security-critical device is designated as a device to be secured; however, the term can also relate to devices or networks having devices which should in principle be protected from unauthorized accesses from the external network. These can be connected to a network. For different purposes, for example servicing or control purposes, it is desirable that these security-critical devices are reachable from external, non-secured networks, for example the Internet. However, this accessibility has the disadvantage that also unauthorized persons can access these devices and, where applicable, cause damage. Hence it is desirable to be able to control the data traffic between the external network and the device to be secured and to prevent unauthorized accesses as nearly as possible. Firewalls can be employed for this. These are switched between the external network and the security-critical device or an internal network having such a security-critical device; in the process, the internal network needs to comprise only one connection. Within the scope of the present invention, a firewall is understood to mean a device which monitors, while employing pre-specified security rules, the data traffic coming from the external network and, where applicable, forwards said data traffic to the device to be secured. Preferably such a firewall can also monitor, while employing pre-specified security rules, data traffic directed from the device to be secured to the external network and, where applicable, forward said data traffic to the external network. Such a firewall is typically arranged between the external network and the device to be secured and usually comprises a data processing device which can be programmed according to its purpose. Firewalls, in particular their software including the software of employed data or configuration parameters, however, have to be serviced by oneself, for example be adapted to newly recognized or occurring security flaws or to newly occurring attacks. For this purpose an access to the firewall is hitherto necessary in order to adapt this. If this adapting is to be possible from the external network, there is a danger that the firewall itself becomes a target of attacks or attempts at unauthorized access and/or tampering. This is in particular then the case when the firewall itself has an IP address and is visible from the external network.

Hence the present invention is based on the problem of supplying a method for forwarding data packets from an external network by means of a transmission device to a device to be secured, in which the function of the transmission device can be simply adapted or changed from the external network. Further, means are to be stated for carrying out said method.

The object is achieved by a method having the features of claim 1 and in particular a method for forwarding data packets from an external network by means of a transmission device to a device to be secured, in which the transmission device has a first interface for connecting to the external network and a second interface for connecting to the device to be secured, in which data packets from the external network are received via the first interface and are filtered by means of a packet filter of the transmission device, wherein received data packets in dependence on the at least one property of the respective data packet and pre-specified rules of the packet filter, which relate to at least one property, are or are not forwarded to the second interface, and in which every data packet incoming via the first interface is checked whether it contains pre-specified recognition information in a useful data unit of the Internet layer of the TCP/IP model, and only if this is the case useful data of the data packet for changing the transmission device are stored or forwarded to a process for changing the transmission device. Preferably the data packet is, however, not forwarded to the device to be secured.

The object is further achieved by a transmission device having a first interface for connecting to an external network, a second interface for connecting to a device to be secured, a processor connected with the interfaces, and a storage in which software is stored upon whose execution by the processor a method according to the invention, in particular according to any of claims from 1 to 7, is carried out.

A further subject matter of the present invention is a computer program, in particular for forwarding data packets from an external network by means of a transmission device to a device to be secured, which comprises instructions upon whose execution by a data processing device a method according to the invention is executed. Further, a subject matter of the present invention is a data carrier on which a computer program according to the invention is stored. The data carrier can in particular be a physical data carrier, for example an optical or magnetic or magneto-optical storage medium or a data carrier having a flash memory or a hard disk or the like.

In the method, the data packets which come from the external network are forwarded depending on the result of the filtering to the device to be secured. The external network can be an arbitrary, in particular publicly accessible, and not necessarily secure network, for example the Internet. Therein is located at least one data source, for example a data processing device, which sends data in the form of data packets to the device to be secured. This can be a security-critical device as it was mentioned at the outset, or a network to which preferably at least one security-critical device is attached.

In the method, the data packets which come from the external network via the first interface are received and then filtered by the packet filter of the transmission device. Upon the filtering, by means of the packet filter, of data packets received via the first interface, in dependence on at least one property of the respective data packet and pre-specified rules of the packet filter which relate to at least one property, a respective one of the data packets is forwarded to the second interface or no forwarding is effected, the data packet can be discarded, for example. If the transmission device possesses besides the two interfaces a processor, then a packet filter is understood to mean a software component by whose execution by the processor data packets are filtered as described. In the process, the software can comprise data which specify the rules of the packet filter and other properties of the packet filter. The transmission device can further comprise a storage in which software is stored which also comprises the packet filter. The software can further comprise an operating system which is suitable and serves for operating the transmission device, in particular also for the operation of the interfaces.

Upon executing the packet filter, data packets incoming via the first interface are filtered while employing the pre-specified rules of the packet filter. For this purpose every data packet incoming via the first interface is thereupon checked whether it has to be forwarded or not according to the pre-specified rule and in dependence on at least one pre-specified property.

The method according to the invention is characterized in particular by the fact that certain data packets for changing the transmission device, preferably its software, are recognized and diverted. A data packet incoming via the first interface is thereupon checked whether it contains a pre-specified recognition information item. This recognition information item has to be contained in a pre-specified portion of the data packet, namely in the useful data unit of the Internet Layer. Within the scope of the present invention, the useful data unit of the Internet Layer designates a portion of the data packet which is transferred with a protocol in the Internet Layer of the TCP/IP model. This, however, does not contain the protocol data of this protocol of the Internet Layer or subjacent layers, for example corresponding headers or footers.

Only if it is ascertained upon the check that the pre-specified recognition information item is present in the data packet, are useful data of the data packet or data of the useful data unit of the data packet, which contains the recognition information item, stored at least partly for changing the transmission device or forwarded to a process for changing the transmission device. However, the data packet is preferably not forwarded to the device to be secured. Preferably this check is carried out before the end of the processing of the data packet by means of the packet filter, preferably before the processing of the data packet by means of the packet filter.

In the method, data packets can preferably be received independently of the information or data contained therein with respect to the Network Access Layer of the TCP/IP model and preferably the Internet Layer, and be further processed, that is checked for the presence of the recognition information item and/or subjected to the filtering. In the process, the information or data relating to the Network Access Layer or the management layer are understood to be information items which are employed for employment by protocols in these layers, for example information items in corresponding headers or footers. Preferably in particular the first interface can be configured and operated by means of the software such that data packets are received and further processed via the first interface independently of their MAC address. Particularly preferably the transmission device in the method has no IP address. The transmission device is hence non visible from the external network. The transmission device then represents preferably a transparent firewall.

Further, the data packets which are forwarded to the second interface remain preferably unchanged in the method. There is no guidance or routing of the data packets on the path up to the second interface, which can also be a virtual interface of the operating system supplied by the operating system. The transmission device then represents preferably a bridging firewall. Because no deflection of data packets takes place and the filtering takes place independently of the MAC address, such a transmission device has the advantage that it can be simply switched between an external network and the device to be secured, without having to change network addresses. Upon combination with the above-depicted configuration in which the firewall is transparent, there results a method or a transmission device which is hardly recognizable from outside, that is from the external network.

The recognition information item can in principle be present at an arbitrary position of the useful data unit of the IP layer. Preferably it is, however, present in a portion of the useful data unit which contains protocol data for a protocol of the Transport Layer.

In the method, the data packets can in particular be TCP or UDP packets and the pre-specified recognition information item in the Transport Layer can comprise a port address, or the pre-specified recognition data in the Transport Layer can represent port addresses. The TCP or UDP data packets are understood to mean data packets which are transferred by means of TCP or UDP protocol, wherein these protocols are applied in the Transport Layer or the transmission in the Transport Layer. This allows transferring data packets with conventional protocols.

As a further securing means, it is preferred in the method that the useful data of the packet are cryptographically secured. For example they can be encrypted and/or signed. This has the advantage that even in the case that the recognition information item becomes known, a change of the transmission device by third parties is very much impeded or prevented. For encrypting and/or signing, in particular a key can be employed which is coupled to an unambiguous identification character string of the transmission unit, for example an unambiguous hardware identifier such as a MAC address or a chip serial number.

In the method, the useful data stored or forwarded to the process are employed preferably for changing the transmission device. For this, the software or the computer program comprises preferably instructions upon whose execution the stored useful data are employed for changing the transmission device, preferably of the software, is employed or the process is executed. Thus it is preferred that the software is given in the transmission device such that upon their execution the software is changeable. It is changed in case data packets having the recognition information item and corresponding useful data are received.

Upon employment of such a transmission device, a change of the same from the external network is simply possible. The subject matter of the present invention is also a method for changing a transmission device for forwarding data packets from an external network to a device to be secured, wherein a first interface of the transmission device is connected to the external network, in which at least one data packet is generated, which contains in a useful data unit of the Internet Layer of the TCP/IP model, preferably in the Transport Layer, a pre-specified recognition information item and useful data for changing the transmission device, the data packet is transferred to the first interface and is processed there with a method according to one of the preceding claims. The recognition information item can be, in the case of TCP or UDP data packets, in particular port addresses as previously explained. In the process, the transmission to the first interface needs to be effected not in a targeted manner, rather it suffices to send the data packets to an address on the network to be secured or the address of the device to be secured.

Correspondingly also subject matter of the present invention is a system having a device to be secured, a transmission device according to the invention and a management entity, in which the device to be secured is connected to the second interface of the transmission device and the management entity to the first interface of the transmission device via an external network, and in which the management entity is configured for generating management data packets which contain in a useful data unit of the Internet Layer of the TCP/IP model a pre-specified recognition information item and change data for changing the transmission device, and to send these via the external network to the device to be secured. The management entity can preferably be a data processing device which contains software upon whose execution management data packets are generated which contain a pre-specified recognition information item and change data for changing the transmission device in a useful data unit of the Internet Layer of the TCP/IP model, and to send this via the external network to the device to be secured. If the device to be secured is a network to be protected, the management data packets can be sent to any address on the network, because they are not forwarded anyway by the transmission device, but employed for changing the transmission device.

A transmission device according to the invention can be in particular a firewall device.

The invention will hereinafter be explained further by way of example with reference to the drawings. There are shown:

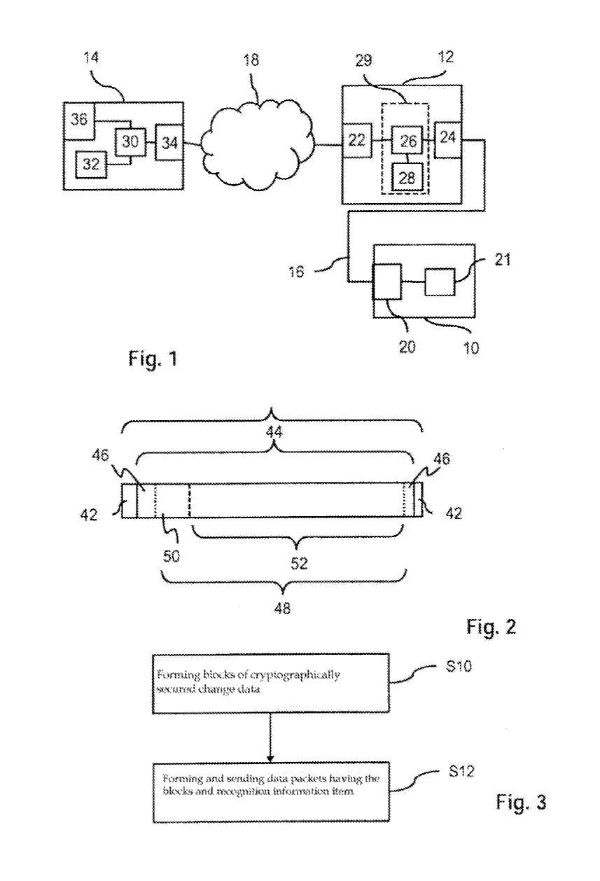

FIG. 1 a schematic representation of an example of a system having a management entity, a transmission device connected thereto via an external network and a device to be secured connected to the transmission device,

FIG. 2 a schematic representation of an example of a data packet employed for changing the transmission device,

FIG. 3 a very schematic flowchart of an example for the forming and the sending of data packets for changing the transmission device, and

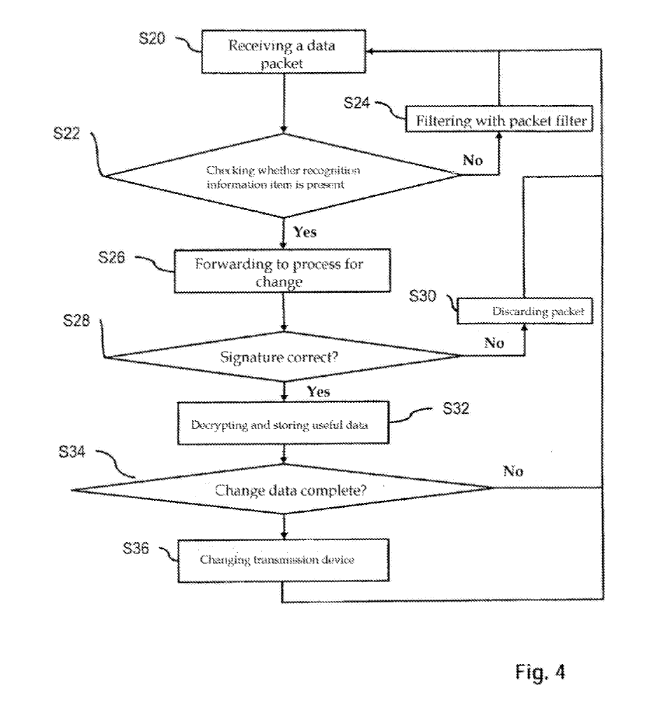

FIG. 4 a very schematic flowchart of an example of the treatment of received data packets by the transmission device.

A system in FIG. 1 comprises a device to be secured 10, a transmission device 12 and a management entity 14 in the form of a data processing device. The device to be secured 10 and the transmission device 12 are interconnected via a data connection 16, in the example a LAN connection, so that they can exchange data. The transmission device 12 is further connected to the management entity 14 via a publicly accessible, external network 18, for example the Internet, so that data can be transferred from the management entity to the external network. At least one other data processing device, not shown in FIG. 1, can still be connected to the external network, in particular a data processing device which can receive data from the device to be secured and/or send data to this.

The management entity 14 is configured for sending data via the external network 18 which serve for changing the transmission device 12, in particular its function.

The device to be secured 10 comprises a security-critical device which should be able to receive data for different purposes from the external network 18 and/or to send data to the external network. For this purpose it has a network interface 20, for example a LAN interface, and a control device 22, which, for example, has [sic—Verb fehlt] a processor (not shown) connected to the network interface 20 and a storage which the processor can access and in which software is stored, which serves for operating the device 10, on the one hand, and is devised for sending and receiving data from the external network, on the other hand. In particular the device 10 can be assigned a separate IP address.

For securing against unauthorized access from the external network 18, the device to be secured 10 is in the example connected to the transmission device 12 by means of the network interface 20, which monitors and filters the transport of data from the external network 18 to the securing device 10 and from the device to be secured 10 on the external network.

In the present example, the transmission device 12 comprises a data processing apparatus 12 having a first network interface 22, a second network interface 24, a processor 26 connected these network interfaces, and a storage 28 connected to the processor 26 in which software for operating the transmission device 12 is stored when the processor executes the software.

The second network interface 24 is connected via the data connection 16 to the device to be secured 10, the first network interface to the external network 18.

The software of the transmission device 12 comprises, besides components for an operating system and in particular for operating the network interfaces 22 and 24, a software component upon whose execution by the processor 26 of the transmission device 12 filters by means of a packet filter 29 the data traffic between the external network 18 and the device to be secured 10; in FIG. 1 the packet filter is symbolized by dashed lines. Besides instructions executable by the processor of one or several computer programs, the software can also contain configuration data which are employed upon the execution of the instructions. The transmission device 12 is not assigned a separate IP address.

More precisely, the monitoring device 12, in particular their first network interface 22 and the software of the monitoring device is configured such that data packets coming from the external network 18 are received independently of their addressing, in particular of the addressing at the Network Access Layer and the Internet Layer of the TCP/IP model. In the example, incoming data packets are thus received at the first network interface 22 independently of their source address and in particular target address as well as independently of their IP address. In the process, the data packets which are forwarded as a result of the filtering to the second network interface remain unchanged, a routing does not take place. The transmission device 12 thus works as a transparent bridge having a firewall function. Because it receives data packets independently of their MAC address and is also not assigned an IP address, it is not visible from the external network and not readily activatable.

In the normal operation, received data packets are or are not forwarded by the packet filter on the basis of rules of the packet filter. Hereinafter this is designated as conventional filtering. The rules are stored in the transmission device 12, in this example in the form of parameters or configuration data, and relate in this embodiment example to protocol information items of protocols of the Internet Layer and Transport Layer of the TCP/IP model, in particular IP addresses. Data packets whose content does not correspond to the rules are discarded, those whose content corresponds to the rules are forwarded to the second network interface 24 unchanged. An example of such a filter is the packet filter iptables.

The transmission device 12 or its software, in particular, but not only, the software for the packet filter including the rules, should be able to be changed however. The changes can relate to, for example, parts of the software in the form of computer program instructions or only configuration data, for example for the rules of the packet filter. Operating system updates can be also carried out as changes. The transmission device 12 is hence configured for executing a method according to the invention for forwarding data packets, which is further explained hereinafter. The changes to relevant data are made available by the management entity 14.

In the present embodiment example, the management entity 14 comprises a data processing device 14 having a processor 30, a storage 32 connected to the processor 30 in which a management software to be executed by the processor 30 is stored, a network interfaces 34 connected to the processor 30, which is connected to the external network 18, and an input/output unit 36 by means of which operator-control data for a user are capturable and inputs of a user are displayable. For example, the input/output unit 36 can comprise a display device and a keyboard having a pointing device, alternatively a touch screen. The software is in particular constituted or configured such that the management device 14 can generate and send change information items for the transmission device 12. The corresponding method will be described more precisely hereinafter.

Hereinafter reference is made to the structure of data packets, which the transmission device 12 processes. In a description in the TCP/IP model these can be structured in a per se known manner. The transfer of a useful data block of suitable size is effected by means of a data packet while employing a protocol hierarchy which is described in the TCP/IP model.

For forming a data packet, a useful data block is packaged by the process which obtains the useful data block, typically in a protocol data frame which comprises necessary protocol data for the processing of the protocol. For the purposes of the present invention, a protocol data frame can comprise in dependence on the protocol in particular only one header or only one footer or both a header and a footer. The thus formed protocol data frame having the useful data block is delivered as a useful data unit to a further process which in turn packages this into a protocol data frame of a further protocol. This is continued analogously until the protocol is attained which is employed at the physical level.

Thus the structure of a data packet 40 results as illustrated in FIG. 2. The data packet contains in a protocol data frame 42 of the Network Access Layer the protocol data of the corresponding protocol employed for transmitting in the Network Access Layer, here for example the Ethernet protocol, and a useful data unit 44 of the Network Access Layer. The protocol data comprise in particular source and target MAC addresses of the transmitter or receiver.

The useful data unit 44 of the Network Access Layer comprises a protocol data frame 46 of the Internet Layer of the TCP-IP model, the protocol data of the corresponding protocol employed for transmitting in the Network Access Layer, and a useful data unit 48 of the Internet Layer. Among other things, the protocol data frame contains the IP addresses of the transmitter and the receiver.

The useful data unit 48 of the Internet Layer in turn contains in a protocol frame 50 of the corresponding protocol [sic—“Protokolls-und” fehlt was] employed in the Transport Layer a useful data unit 52 of the Transport Layer. The protocol data of the protocol frame contain a port number among other things. The useful data unit 52 of the Transport Layer contains the useful data which are employed by the receiver. Insofar as no further protocol is employed, these useful data can be employed by the receiver.

The management data packets which are formed in pre-specified manner are employed for changing the transmission device 12.

In this embodiment example the data packets which employ the TCP protocol are employed. They contain in a useful data unit of the Internet Layer of the TCP/IP model a pre-specified recognition information item, in the example in the useful data unit 48 of the Internet Layer a protocol frame 50 which contains a pre-specified port number, and in the useful data unit 52 of the Transport Layer data to be employed for changing the transmission device 12. The port number is chosen from the region above the standard port numbers, in the example above 19999. In the present embodiment example, the data are cryptographically secured in the useful data unit 52, i.e. are for example encrypted and signed.

The following method is now carried out by the management entity 14.

TCP data packets, which are addressed to an IP address of the device to be secured, are formed by the management entity, where applicable, while employing the input/output device 36, from the data to be employed for changing, which was previously created and stored in the management entity 14. For this purpose the data, insofar as the amount of data is too large for a data packet, are in step S10 divided into portions of suitable size, and are cryptographically secured, in the example in encrypted form, and signed.

In step S12, each of the portions is packed as a useful data unit 52 into a TCP protocol data frame 50, which contains the pre-specified port number. In the process the frame can be just a header. The thus resulting useful data unit 48 of the Internet Layer is furnished with the IP protocol data frame 46, which contains the IP address, and the thus resulting packet, for example inserted into an ethernet packet, is sent.

By means of the transmission device 12, the following method is carried out, for which its software to be executed by the processor is configured correspondingly.

In step S20 the transmission device 12 receives a data packet at the first network interface 22. As stated above, data packets are in the process received independently of the information contained therein with respect to the Network Access Layer of the model TCP/IP, in particular the source MAC and target MAC address and preferably the Internet Layer of the TCP/IP model, in particular the source address and target IP address.

In step S22 it is checked whether the data packet contains pre-specified recognition information item in a useful data unit 48 of the Internet Layer of the TCP/IP model. In the present example the data packets are TCP or UDP packets. The pre-specified recognition information item in the Transport Layer comprises a port address which is contained in the useful data unit 48 of the Internet Layer, more precisely in the protocol data frame 50, in the example the TCP or UDP header.

If the checking yields that no recognition information item is contained, thus that either no port number was found or the port number does not match the pre-specified port number, the processing is continued with step S24 in which a conventional filtering is carried out with the packet filter. Depending on the result of the filtering, the packet is or is not forwarded unchanged to the second interface, in the example it is discarded. Thereafter the method is continued with step S20 for a newly incoming data packet.

Otherwise, that is to say, only if the recognition information item was found, in step S26 the useful data unit 48, or in other embodiment examples only the useful data unit 52, is forwarded to a process for changing the transmission device which is executed by the transmission device.

In step S28 the process executed in the transmission device 12 checks the signature of the useful data unit 52. If this is not correct, the packet is discarded in step S30. The method is continued with step S20 for a new data packet.

If the signature is correct, the process decrypts the useful data unit 52 in step S32 and stores the decrypted data. In step S34 it is then checked whether the decrypted data, where applicable, with stored data of previously received data packets, comprise all change data or are complete. If this is not the case, the method it is continued for the next data packet with step S20.

After reception of the last packet having change data from the management data entity, the change of the transmission device 12, here the software, can then be carried out in step S36 by the same process of the transmission device 12 while employing the stored data. Thereafter, or in other embodiment examples simultaneously, the method can be continued with step S20.

In other embodiment examples the useful data do not need to be forwarded to a process, but are first stored and then forwarded to a process for changing the transmission device, which corresponds to the process in step S36.

In still other embodiment examples the securing device is an internal network with at least one security-critical device and a further, where applicable likewise security-critical, device. The management data packet can then be sent to one of the IP addresses.

1.-13. (canceled)

14. A method for forwarding data packets from an external network by means of a transmission device to a device to be secured, in which the transmission device has a first interface for connecting to the external network and a second interface for connecting to the device to be secured, in which data packets from the external network are received via the first interface and are filtered by means of a packet filter of the transmission device,
wherein received data packets in dependence on at least one property of the respective data packet and pre-specified rules of the packet filter, which relate to the at least one property, are or are not forwarded to the second interface, and in which every data packet incoming via the first interface is checked whether it contains pre-specified recognition information in a useful data unit of the Internet layer of the TCP/IP model, and only if this is the case useful data of the data packet for changing the transmission device are stored or forwarded to a process for changing the transmission device.

15. The method according to claim 14, in which data packets are received, independently of the therein contained information with respect to the Network Access Layer of the model TCP/IP.

16. The method according to claim 14, in which the data packets forwarded to the second interface remain unchanged.

17. The method according to claim 14, in which the data packets are TCP or UDP packets and the pre-specified recognition information item in the Transport Layer comprises a port address.

18. The method according to claim 14, in which the transmission device has no IP address.

19. The method according to claim 14, in which the useful data of the packet are cryptographically secured (is encrypted and/or signed).

20. The method according to claim 14, in which the useful data stored or forwarded to the process are employed for changing the transmission device.

21. The method for changing a transmission device for forwarding data packets from an external network to a device to be secured,
wherein a first interface of the transmission device is connected to the external network, in which at least one management data packet is generated, which contains in a useful data unit of the Internet Layer of the TCP/IP model pre-specified recognition information and change data for changing the transmission device, the data packet is transferred to the first interface and is processed there with a method according to claim 14.

22. The transmission device for forwarding data packets from an external network to at least one device to be secured, having a first interface for connecting to the external network, a second interface for connecting to the device to be secured, a processor which is connected to the interfaces, a storage in which instructions of a computer program are stored upon whose execution by the processor the method according to claim 14 is carried out when the first interface is connected to the external network.

23. The transmission device according to claim 22, in which the instructions of the computer program are given such that upon their execution the instructions of the computer program are changed.

24. A computer program which comprises instructions upon whose execution by a data processing device a method according to claim 14 is executed.

25. A data carrier on which a computer program according to claim 23 is stored.

26. A system having a device to be secured, a transmission device according to claim 22 and a management entity, in which the device to be secured is connected to the second interface of the transmission device and the management entity to the first interface of the transmission device via an external network, and in which the management entity is configured for generating management data packets which contain in a useful data unit of the Internet Layer of the TCP/IP model pre-specified recognition information and change data for changing the transmission device, and to send these via the external network to the device to be secured.
